(19) United States
(12) Patent Application Publication
(10) Pub. No.: US 2013/0004934 A1
(43) Pub. Date: Jan. 3, 2013

(54) METHOD OF ORGANIZING THE POPULACE BY ESTABLISHING NEIGHBORHOOD SOCIAL-SAFETY CLUBS IN EVERY NEIGHBORHOOD AND A CITY-WIDE COMMUNICATIONS NETWORK THAT WILL THEN ALLOW FOR THE ESTABLISHMENT OF A CITY-WIDE EVACUATION PROGRAM

(76) Inventor: Brett William Oliver, San Diego, CA (US)

(21) Appl. No.: 13/489,221

(22) Filed: Jun. 5, 2012

Related U.S. Application Data
(60) Provisional application No. 61/493,466, filed on Jun. 5, 2011.

(51) Int. Cl. G09B 25/00

(52) U.S. Cl. 434/365

(57) ABSTRACT

A method of organizing the populace consisting of forming and maintaining a standardized neighborhood social-safety club for every 50-150 adjacent homes sot that they can be trained on disaster preparedness as a group, be able to rapidly evacuate as a group in ant orderly fashion as part of a city-wide evacuation program involving multiplicities of such clubs, be able to shelter-in-place as a group during a disaster, be able to reduce crime in their neighborhood as a group and be able to increase their sense of community by interacting frequently as a group or sub-group, linked to other standardized neighborhood social-safety clubs across the city, thus coordinating their activities, leading to a city-wide social-safety network linked through in-person meetings, a secure online private network, and a standardized radio system using a combination of walkie-talkies and ham radios.

### BACKGROUND OF THE INVENTION

This invention relates to methods of establishing and maintaining a city-wide network of standardized neighborhood “prepared and ready” social-safety clubs involving a secure online communication system based on authenticated faces, an emergency radio system and a safety team in each club trained on evacuation and safety procedures for the purposes of reducing crime, increasing disaster preparedness, creating a sense of community and establishing an effective city-wide evacuation program.

With recent events around the world it has become necessary to consider the possibility of effective city-wide evacuation procedures and a more complete education of the populace on the possible threats. Prior to the invention of this method of organizing the populace there has been no broad-based systematic way to organize the populace in such a way as to have them form groups that will work together during a disaster or evacuate together on command.

Prior to this method, attempts to organize or educate have been sporadic. Neighborhood Watch is embraced by all, then falls on the backs of a few, and then finally tapers out so that only the signs are left. Disaster preparedness training is done once, and then forgotten. Supplies are bought, and then neglected. Cities do not even attempt to consider the populace part of the solution in a large disaster. When neighbors are asked, would you like to meet your neighbors, very often the answer is “No!” Yet any successful program would require the neighbors to check on each other after a disaster, know who in the neighborhood needs help, know who can help when cities services are too overwhelmed to respond. Any city manager will make clear that a city-wide evacuation is very hard to accomplish without the cooperation of the populace.

Gaining the cooperation of the populace, and furthermore training the populace to practice evacuation drills, neighborhood by neighborhood, is the core of this method. Currently there are pockets of very well prepared and trained neighborhoods and small towns. However, when it comes to the larger cities the population has become disconnected, neighbor-to-neighbor. In order for the city manager, police chief or fire chief to order an evacuation of a city, neighborhood by neighborhood in an orderly fashion, there needs to be the following:
A. A communication system in place which can be targeted to each neighborhood, which is a two-way system
B. A hierarchy of communications, where the city evacuation coordinator can communicate rapidly with specific personnel in each neighborhood, who can then in turn communicate rapidly with each neighbor, which is also a two-way system
C. A populace that has been trained beforehand on evacuation procedures, what supplies to bring, where to assemble, what radios to use, what frequencies to use, and who is part of their neighborhood safety team
D. A populace that is willing to cooperate, trusts their safety team, and will work together during an emergency
E. Safety team members that trust their government officials as to information and direction
F. Prior drilling of the evacuation process, neighborhood by neighborhood, with the city officials as participants
G. A communications network that links the specific safety team members in each neighborhood, with their counterparts in other neighborhoods, such as all volunteer evacuation coordinators connected in a city-wide club, thus allowing for the dissemination of relevant information to individuals of that type
H. A merit-badge scoring system, allowing neighbors to earn safety points for learning each skill, and thus creating a system of measuring the readiness of each neighborhood, making it easier to detect those neighborhoods that would need more attention in getting prepared

To implement the above, using government funds, has proven ineffective. The CERT program (Community Emergency Response Team) program offered by fire departments, trains individuals on disaster preparedness, but does not train them on how to organize their neighborhoods and has not established a standardized communications system. Oxnard, Calif., fire department trained 2,000 people in the CERT program, with not one of them forming a team in their neighborhood. Although CERT teams have formed in other cities, this has been sporadic, with insufficient teams to guarantee a city-wide evacuation in an orderly fashion.

The core of our program is trust. We help neighbors build trust with other neighbors in their neighborhood, we help the business professionals that sponsor the clubs build trust with the neighbors in those clubs and we help the safety teams that are formed within those clubs build trust with city officials. Without trust, the system breaks down.

Anyone can want a safer, better prepared neighborhood. It has been one in the past in a sporadic fashion. However, the author knows of no city in the world that has implemented a city-wide safety program by establishing hundreds of standardized neighborhood social-safety clubs and linking them together in a city-wide communications network.

An invention, in order to be patentable, according to the understanding of the author, has to be original, unique, have a social benefit, be useful, and, importantly, be able to be applied in the real world. The components needed have been available for some time, including equipment, training, personnel and funding (FEMA has spent billions on other items). However, by including the business professional that wants to increase business by building trust with neighbors, and is also willing to sponsor one of more neighborhood safety clubs, and thus make a fund available from which to pay for a specially trained club moderator who will knock on doors or otherwise communicate to invite the neighbors to the first meeting, we have isolated both a motivated funding source and feet on the ground that will get these clubs formed and operational. The involvement of this business person is a clearly defined part of the process steps outlined within the invention. The business person (pays for a full time person, who is trained in the program and can organize 1,000 families in 10 neighborhood safety clubs. We have calculated that it costs about $50 per family per year to keep the safety network fully operational. That is $50,000 per year per 1,000 homes. The business person is usually a real estate agent willing to share his or her commission to cover this ongoing cost. For the business person this is a customer procurement expense, as helping the neighborhood helps build relationships. Thus, what is claimed within this invention is actually implementable in the real world. Recent tests involving 65 business people sponsoring clubs has proven that this component of the invention works. Also, testing has proven that 10% of population will actively volunteer for the safety team positions, 70% will go along with the program and 20% will remain anti-social. Thus this is an 80% applicable solution.

As an example of how this invention is applied, we will use the city of Thousand Oaks, Calif., with a population of 127,000 in 41,000 residences. Currently there is no way to evacuate the city in a timely manner. However, with this invention applied to this city over a period of six months to one year, this city could claim to be evacuation ready. It would be done by establishing 800 Neighborhood Prepared & Ready Clubs (social-safety clubs as described above). Then establishing a safety team consisting of a meeting organizer, evacuation coordinator, an online administrator, barn radio operator (hand held 2 meter), trainer, survey takers to establish an evacuation list, resources list, help needed list.

The neighbors would buy walkie talkies, with a different frequency assigned to each neighborhood. The neighbors would drill together to evacuate to a park for a picnic. The ham radio volunteers would link up in a city-wide online club, with 800 of them in this particular club. The city manager, fire chief and police chief would assign personnel to participate in the online network, developing trust with the 800 organizers, that are also in a city-wide club. Then the city could plan evacuation routes with neighborhood clubs being activated one-by-one, leaving security volunteers behind in each neighborhood to dissuade looting, if appropriate.

This allows for the orderly flow of traffic out of the city through predetermined routes with 5 minute gaps between adjacent neighborhoods. However 40 neighborhoods on the edge of the city would be activated first, followed by the next adjacent neighborhoods, thus allowing the city to be evacuated in about 1 hour and 40 minutes. The neighbors, having a number assigned to each neighborhood, would display that number in the front and back windows of each vehicle and keep in touch using the walkie-talkies. Thus they would arrive at their out-of-town assembly point With their to-go packs as a group, and thus know the people around them and the resources available within the group. The local police would simply keep the intersections open, knowing that all of a particular neighborhood had gone through using the numbering system mentioned above.

If this was a prolonged evacuation they would use the online network for that city as their way of keeping in touch with the city officials, their fellow neighbors, and their adjacent neighborhoods. In other words, the city would still remain in touch as a unit, and city officials could use this private online network to notify those neighborhood teams that it deemed see to return to their homes.

### SUMMARY OF THE INVENTION

A method of organizing the populace by forming and maintaining a standardized neighborhood social-safety club for every 50-150 adjacent homes so that they can be trained on disaster preparedness as a group, be able to rapidly evacuate as a group in an orderly fashion as part of a city-wide evacuation program involving multiplicities of such clubs, be able to shelter-in-place as a group during a disaster, be able to reduce crime in their neighborhood as a group and be able to increase their sense of community by interacting frequently as a group or sub-group, and so that they can be linked to other standardized neighborhood social-safety clubs across the city so that they can coordinate their activities, thus leading to a city-wide social-safety network that is linked through in-person meetings, a secure online private network, and a standardized radio system using a combination of walkie-talkies and ham radios.

This method, in order to be implementable, must be done in a specific order. Knocking on a few doors and chit-chatting about safety is not going to get a city-wide evacuation program in place. It depends on a series of presentations, trainings, briefings, recruiting of volunteers, supplemental material and approaching the right people in the correct sequence in order to make this work. Without the motivated business person, it does not work. Without a compensated and dedicated in-neighborhood club moderator it does not work. Without the radio training it does not work. Without the motivated neighbors it does not work. Without the volunteer online network administrator and the secure online private network it does not work. Without key material it does not work. Without the correct wording when knocking on doors it does not work. Without group drilling, such as “evacuate to a park for a picnic” it does not work. If it was done by a political party, the government or a religious group it will not work. It needs to be implemented by a non-religious, non-political organization in order to work. It's core is building trust between the parties involved, which must be done in an exact sequence, and then establishing agreed upon communication protocols and the proper training. This must be done in a social setting, but under the premise of safety and evacuation training. Without the social setting the neighbors do not show up for training. It has taken years of in-the-field research to discover the exact sequence and method needed to implement a city-wide evacuation program. This is a social engineering type of invention, where applying this method will lead to the four benefits of reducing crime, increasing disaster preparedness, creating a sense of community and establishing an effective evacuation program.

### DESCRIPTION OF THE PREFERRED EMBODIMENT

The following is the minimum required steps in order to establish a city-wide evacuation program by establishing standardized social-safety clubs:

1. Recruit and train a city coordinator on all the parts of the program (see addendum 1)

2. The city coordinator then recruits business professionals that wish to sponsor specific neighborhoods as the official safety team sponsor

3. Recruit in-neighborhood club moderators, with one per 1,000 homes (10 safety clubs), who is then trained on how to implement the program in the sponsored neighborhood (see addendum 2)

4. The moderator, with the help of the city coordinator, arrange a neighborhood get-together in a neighbors home

5. At the neighborhood get-together the city coordinator or moderator explains the program and has the neighbors fill out the volunteer form, with an eye to finding an online administrator, a trainer, an organizer and a ham radio operator (see addendum 3)

6. The online administrator is then trained by the city coordinator, who then puts his or her neighbors onto the private secure online system, which includes authenticated faces and “Talking point” items to make it easier for neighbors to get to know each other

7. The trainer then follows the training program outlined, getting the neighbors disaster prepared in a series of neighborhood get-togethers, culminating in an “evacuate to a park for a picnic” or similar event

8. The city coordinator then ensures that the organizers in each neighborhood are part of a city-wide online club within the secure private online network, and then connects them up to the appropriate city officials responsible for disaster preparedness and evacuation

9. The sponsors continue to sponsor the neighborhood get-togethers, thus helping to build trust between neighbors, and, by the sponsor attending such events, building trust between the sponsor and the neighbors, thus ensuring an ongoing readiness within the neighborhood

10. The neighbors are encouraged to earn merit badges by attending Red Cross training, ham radio training, CERT training, making sure they have a to-go bag, a water supply, a food supply and so on. The volunteer merit badge coordinator keeps track of the progress of the neighborhood

The above constitutes the method, in its simplest form. However, there can be variations of the method, with some of the steps being modified somewhat, for example, the meetings may be in a community center instead of a neighbors home. A large corporation may sponsor a whole city and have their employees activate safety teams and form clubs in their own neighborhoods.

### PRIOR ART

Two manuals, included in the submission, The Prepared and Ready club manual, and the Inspiring Neighborhood Spirit manual have been written by the author and his wife in order to test out the program. It has taken a couple of years to get this program sorted so that it is “workable” in the real world. What is not included in these manuals is the most important component. The paid club moderator who organizes, and keeps organized 1,000 families in 10 social/safety clubs. When this program was tried using real estate agents as the organizers they failed to continue keeping the system operational. In order to pay the moderator it was necessary to request a sizable percentage of real estate agents commissions, which they have agreed to. As such, with this component added, the invention is fully able to deliver as promised.

### PROVISIONAL APPLICATION

This application is associated with Application No. 61/493,466, with the addition of the “paid moderator” acting as the glue that keeps the system operational.

It was filed Jun. 5, 2011.

The embodiments of the invention in which an exclusive property or privilege is claimed are defined as follows:

1. A method of organizing the populace consisting of forming and maintaining a standardized neighborhood social-safety club for every 50-150 adjacent homes so that they can be trained on disaster preparedness as a group, be able to rapidly evacuate as a group in an orderly fashion as part of a city-wide evacuation program involving multiplicities of such clubs, be able to shelter-in-place as a group during a disaster, be able to reduce crime in their neighborhood as a group and be able to increase their sense of community by interacting frequently for various reasons as a group or sub-group, and so that they can be linked to other standardized neighborhood social-safety clubs across the town or city so that they can coordinate their activities, thus leading to a city-wide or town-wide social-safety network that is linked through in-person meetings, a secure online private network, and a standardized radio system using a combination of walkie-talkies and ham radios, where the steps of the method are (a) recruit and train a city coordinator on all the parts of the program, (b) the city coordinator then recruits business professionals that wish to sponsor specific neighborhoods as the official safety team sponsor, (c) recruit in-neighborhood moderators who are then trained on how to implement the program in the sponsored neighborhood, (d) the moderators, with the help of the city coordinator, arrange a neighborhood get-together in a neighbors home, at the neighborhood get-together the city coordinator or moderator explains the program and has the neighbors fill out the volunteer form, with an eye to finding an online administrator, a trainer, an organizer and a ham radio operator, (e) the online administrator is then trained by the city coordinator, who then puts his or her neighbors onto the private secure online system, which includes authenticated faces and “Talking point” items to make it easier for neighbors to get to know each other, (f) the trainer then follows the training program outlined, getting the neighbors disaster prepared in a series of neighborhood get-togethers, culminating in an “evacuate to a park for a picnic” or similar event, (g) the city coordinator then ensures that the moderators in each neighborhood are part of a city-wide online club within the secure private online network, and then connects them up to the appropriate city officials responsible for disaster preparedness and evacuation, (h) the sponsors continue to sponsor the neighborhood get-togethers, thus helping to build trust between neighbors, and, by the sponsor attending such events, building trust between the sponsor and the neighbors, thus ensuring an ongoing readiness within the neighborhood, (i) the neighbors are encouraged to earn merit badges by attending Red Cross training, ham radio training, CERT training, making sure they have a to-go bag, a water supply, a food supply and so on, and the volunteer merit badge coordinator keeps track of the progress of the neighborhood.

2. A method of organizing the populace recited in claim 1 wherein said method comprises the provision of a standardized emergency communication system for communication between each neighborhood safety team and emergency services, using assigned radio frequencies and said private secure online network.

3. A method of organizing the populace recited in claim 1 wherein said method comprises said private online secure network with a private club site for that neighborhood, administered by the moderator assigned to that neighborhood.

4. A method of organizing the populace recited in claim 1 wherein said method comprises said private online secure network with a private club site for each type of volunteer, such as a city-wide online club for moderators from each neighborhood, thus making it easier for city-wide dissemination and coordination.

5. A method of organizing the populace recited in claim 1 wherein said method comprises accepting a request from a business for approval of an advertisement targeted for said neighborhood for display on the club site for said neighborhood as a digital billboard message linked to am authenticated facial image corresponding to a member of said business displayed on said secure communication system, thus allowing, as an example, a tree-trimmer to place an ad that is targeted to a specific street or neighborhood.

6. A method of organizing the populace recited in claim 1 wherein said method comprises providing a portable wireless communications device interface communicating information sufficient to identify a neighbor enrolled in said organization having an authenticated facial image displayed by said secure communication system and providing said authenticated facial image to said device on demand.

7. A method of organizing the populace recited in claim 1 wherein said method comprises placing a digital video camera in said neighborhood transmitting a signal from said digital video camera to said secure communications system monitoring said signal and alerting said safety team when said signal indicates the need for intervention.

8. A method of organizing the populace recited in claim 1 wherein said method comprises displaying profile information corresponding to said authenticated facial images and providing an online club whereby said neighbors may selectively interact with each other based on said profile information.

9. A method of organizing the populace recited in claim 1 wherein said method comprises selecting at least one subset of said plurality of neighbors occupying a predetermined number of substantially adjacent homes; and, providing at least one online club private to said subset of said plurality of neighbors concerning a specific subject, such as the “safety team” club or the “dinner and movie” club.

10. A method of organizing the populace recited in claim 1 wherein said method comprises the predetermined number of about 50-150, being a natural size for a group where individuals can get to know and trust each other sufficiently to care to help each other in an emergency.

11. A method of organizing the populace recited in claim 1 wherein said method comprises the ability to implement an organized city-wide evacuation capability through being able to selectively evacuate neighborhoods.

12. A method of organizing the populace recited in claim 1 wherein said method comprises the ability to significantly reduce crime, through rapid communication between neighbors and between neighborhoods, with the use of the authenticated facial image online private network to help recognize who is supposed to be in the neighborhood.

13. A method of organizing the populace recited in claim 1 wherein said method comprises the ability to re-unite families, neighbors and friends that have been dispersed to different areas after a disaster by using said secure online network.

14. A method of organizing the populace recited in claim 1 wherein said method comprises the ability to get neighbors to participate, by using “Would you like to be on the evacuation list?” or similar wording, as this question, when explained, results in 80% participation in the club.

15. A method of organizing the populace recited in claim 1 wherein said method comprises the ability to have strong neighborhood participation, with the use of a Neighbors Prepared & Ready Members Handbook, or similar naming, describing how the club operates and what the hats of the volunteer positions entail and which radio frequencies to use for that particular neighborhood, and where this book could also be represented in DVD form.

16. A method of organizing the populace recited in claim 1 wherein said method comprises the ability to have strong business sponsor participation, with the use of the “Inspiring Neighborhood Spirit manual=building trust in the neighborhood”, or similar wording, describing how the business professional acts as a sponsor within the neighborhood to build trust and thus develop more business, and thus acts as a powerful marketing tool and business development coaching program for said business professionals, and where this book and program could also be represented in DVD form.

17. A method of organizing the populace recited in claim 1 wherein said method comprises allowing the neighborhood, as a group, to purchase large survival items such as a satellite phone or water distillation plant, by establishing a neighborhood club banking system, with accounts for each club and sub-accounts for each neighbor.

18. A method of organizing the populace recited in claim 1 wherein said method comprises a children' network within said online secure communications network, where authenticated adults place their children by taking their picture and placing said picture and name into the system, and can then monitor their own childs' communications in order to dissuade sexual predators from using the system to interact with children, where the authenticating of the adults is done by the neighborhood online administrator that is part of said safety team.

19. A method of organizing the populace recited in claim 1 wherein said method comprises using said secure online network is used for rapid polling or voting on issues, with authenticated accountable identities, thus allowing for rapid, accurate response to issues involving the community.

20. A method of organizing the populace recited in claim 1 wherein said method comprises a multi-year program where the families pay a fixed monthly fee and are guided step by step towards becoming more prepared as both a family and as a group of cooperating families, where the program includes providing training and supplies at discounted rates.
